(19) United States
(12) Patent Application Publication
(10) Pub. No.: US 2010/0315372 A1
(43) Pub. Date: Dec. 16, 2010

(54) TOUCH COORDINATE CALCULATION FOR A TOUCH-SENSITIVE INTERFACE

(75) Inventor: Hon Siong Ng, Singapore (SG)

Correspondence Address: STMICROELECTRONICS, INC., MAIL STATION 2346, 1310 ELECTRONICS DRIVE, CARROLLTON, TX, 75006, US

(73) Assignee: STMicroelectronics Asia Pacific Pte Ltd., Singapore (SG)

(21) Appl. No.: 12/484,044

(22) Filed: Jun. 12, 2009

(51) Int. Cl. G06F 3/045

(52) U.S. Cl. 345/174

(57) ABSTRACT

A touch sensitive interface includes a plurality of touch pads that can each register an impedance change indicating a contact. For each contact a plurality of touch pads is identified and within that plurality of associated touch pads one or more seed points is located. Each seed point possesses an input value greater than the input value at each neighboring touch pad. From each seed point within the plurality of touch pads associated with a contact, a region of touch pads is identified. A centroid of each formed region can then be determined to ascertain a touch coordinate.

### BACKGROUND OF THE INVENTION

1. Field of the Invention

Embodiments of the present invention relate, in general, to touch-sensitive input devices and more particularly to determining a touch coordinate for a touch-sensitive input device using island flooding.

2. Relevant Background

A touch screen system is a computer input device/system capable of receiving input signals for a computer or processor through a pressure sensitive plate. When an input stylus, a pen, or a finger touches the pressure sensitive plate (the ‘touch screen’) at a point on the surface of the touch screen, the touch screen system senses the location of the ‘touch point’ within the area of the touch screen. The touch screen system sends information concerning the location of the touch point to the processor. The processor is operable to associate specific locations on the touch screen with certain predetermined input signals. For example, touching one area of the touch screen may instruct the computer to perform a certain function and touching another area of the touch screen may instruct the computer to perform another function.

Input devices such as a touch screen are designed to detect the application of a force and to determine one or more specific characteristics of that force as relating to the input device. These characteristics may include the location of the force as acting on the input device, the magnitude of force applied by the object to the input device, or the duration of the force.

Currently, there are a variety of different types of input devices available on the market. Some examples include resistive-based input devices, capacitance-based input devices, surface acoustic wave-based devices, force-based input devices, infrared-based devices, and others. While each provides some useful functional aspects, each of these prior related types of input devices suffers in one or more areas.

A resistance-type touch screen is generally a transparent four-layer compound screen of thin film, with the bottom being a base layer made of glass or organic glass, the top being a plastic layer whose outer surface has undergone a cure process and thus becomes smooth and resistant to scratches, and the middle layer comprising two metal conductive layers disposed on the base layer and next to the inner surface of the plastic layer, respectively, the two conductive layers being spaced from each other by many minute (smaller than 1/1000 inch) transparent separating points between them. When the screen is touched with a finger, the two conductive layers contact with each other at the touch point.

The two metal conductive layers are operating faces of the touch screen, and two strips of silver paste are coated to both ends of each operating face respectively and referred to as a pair of electrodes for this operating face. If a voltage is applied to the pair of electrodes for one of the operating faces, a uniform and continuous distribution of parallel voltage will be formed on the operating face. When a prescribed voltage is applied to the pair of electrodes in the X axis direction, and no voltage is applied to the pair of electrodes in the Y axis direction, the voltage value at the touch point can be reflected on the Y+ (or Y−) electrode in the parallel voltage field along the X axis. The coordinate of the touch point along the X axis can be obtained by measuring the voltage value of the Y+ electrode with respect to the ground. Similarly, when a voltage is applied to the pair of electrodes in the Y axis direction, and no voltage is applied to the pair of electrodes in the X axis direction, the coordinate of the touch point along the Y axis can be obtained by measuring the voltage value of the X+ electrode with respect to the ground. Finally, the coordinates of the pressure center point can be obtained by calculating a weighted average of the coordinates of all touch points with a controller for the touch screen.

Most of the touch screen input modes known in the prior art have at least one thing in common: they assume that the touch-sensitive screen is touched at only one point at a time. Indeed, these screens are designed with this assumption in mind. When a user accidentally touches the screen at more than one point (for example, by hitting two ‘virtual keys’ at the same time), these screens become confused and either capture neither touch or, assuming a single touch, compute a location of the assumed single touch that is some combination of the locations of the multiple touches. Either case confuses the user, and the latter case may result in unwanted input being sent to an application reading the screen.

The problem of accidentally touching more than one location at a time has existed at least since the introduction of the typewriter keyboard in the nineteenth century. Indeed the arrangement of the letters on the typewriter keyboard was designed to minimize such multiple key touches. Somewhat alleviating the problem, a user of a physical keyboard can usually tell by feel that he has hit more than one key. Unlike these physical keyboards, however, touch-sensitive screens are so rigid and have essentially no ‘give’ that they cannot provide tactile feedback to tell the user that he is touching the screen at more than one location.

While multiple touches present a problem with the small touch-sensitive screens already in common use, the problem is expected to worsen as larger screens are introduced. This is due to the ‘palm rest’ problem. When using a small screen only a few inches wide, the palm of the user's hand rests, if anywhere, beyond the edge of the screen on the periphery of the computing device. With a larger screen, when a right-handed user selects an area on the left side of the screen, for example, it is natural for the user to rest his right palm below and to the right of the selected point. This palm rest becomes a secondary touch on the screen providing confusing and often conflicting inputs to the processor and associated applications.

One technique for determining the coordinates of a touch well known to one skilled in the art of touch screen technology uses a fixed threshold. The resistance type touch screen described above is incapable of identifying multiple touches. FIG. 1 shows a touch sensitive screen display grid as known in the prior art. Upon touching the screen 110 with a finger 120 a plurality of touch pads 105 is depressed and registers a variety of impedances.

The continuous set of depressed touch pads are grouped into a single touch from which a boundary 130 is formed. From that boundary 130 a centroid 140 can be determined which is used for processing purposes as the singular touch point. Each of the touch pads 105, however, is activated by a predetermined fixed threshold.

When the threshold is set very high, the touch screen is unable to detect small (light) touches; and when the threshold is set low, two or more touches are indistinguishable resulting in a centroid that has little correlation to either touch. For example FIG. 2 shows a touch screen using fixed thresholding in which two touches have occurred but only one touch point is registered. As shown a first touch 210 and a second touch 220 occur substantially at the same time. Both are in excess of the fixed threshold and thus the touch screen 110 registers that a touch has occurred. However all of the touch pads 105 within the boundary area 240 are equally above the predetermined threshold and the centroid 230 that results from those touch pads 105 is not an accurate representation of the center of either the first 210 or the second 220 touch.

One technique capable of detecting multiple touches that is known in the art is referred to as variable thresholding. Rather than setting a fixed threshold wherein each touch is based on surpassing the same threshold, the threshold in a variable threshold technique is determined for each frame based on a histogram of impedance levels. While such a process has the capability of detecting multiple touches, the variable threshold level is dominated by a touch that exists over a larger area. To overcome this problem the percentage of historic levels used to set the current threshold is varied increasing the complexity of the process. Thus, while feasible, variable thresholding requires substantial computational resources making it economically infeasible for many applications.

These and other challenges with respect to accurate and reliable capturing of touch coordinates on a touch sensitive screen are addressed by the present invention, which is hereafter presented by way of example.

### BRIEF SUMMARY OF THE INVENTION

A method and system for determining a touch coordinate associated with a contact to a touch sensitive input device are hereafter described by way of example. According to one embodiment of the present invention, a touch sensitive interface such as a touch screen or touch pad receives a contact such as a finger touch. The touch sensitive interface includes a plurality of touch pads which, as described previously, can register an impedance change indicating an input. According to one embodiment of the present invention, a plurality of touch pads associated with the contact are identified. Within that plurality of associated touch pads one or more seed points are located.

Each seed point possesses an input greater than the input at each neighboring touch pad. From each seed point within the plurality of touch pads associated with a contact, a region of touch pads is identified. Thus from a plurality of touch pads associated with a contact, two distinct seed points can be identified; and from each seed point a separate region is formed. A centroid of each region can then be determined to ascertain a touch coordinate.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE SEVERAL VIEWS OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 shows a touch sensitive interface as known in the prior art;

FIG. 2 shows a touch sensitive interface using fixed thresholding in which two touches have occurred but only one touch point is registered, as is known in the prior art;

FIG. 3 shows a touch sensitive interface having overlapping regions of a two touch scenario that is resolved into two separate touch points according to one embodiment of the present invention;

FIG. 4 shows a plurality of touch pad inputs on a touch sensitive interface experiencing a single touch point according to one embodiment of the present invention;

FIG. 5 shows a plurality of touch pad inputs on a touch sensitive interface experiencing multiple touch points according to one embodiment of the present invention; and

FIG. 6 shows a flow chart of one method embodiment for determining a touch coordinate for a touch sensitive interface according to the present invention.

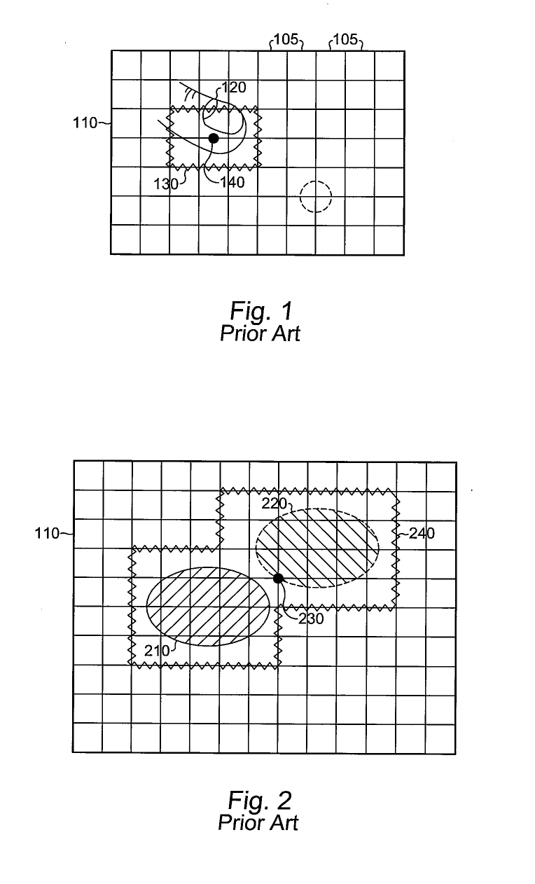

The Figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE INVENTION

Specific embodiments of the present invention are hereafter described in detail with reference to the accompanying Figures. Like elements in the various Figures are identified by like reference numerals for consistency. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

According to one embodiment of the present invention, a touch coordinate is determined for each touch of a touch sensitive interface by identifying one or more seed points. From each seed point a region of associated touch pads is formed, and from each region a centroid can be determined and designated as the touch coordinate.

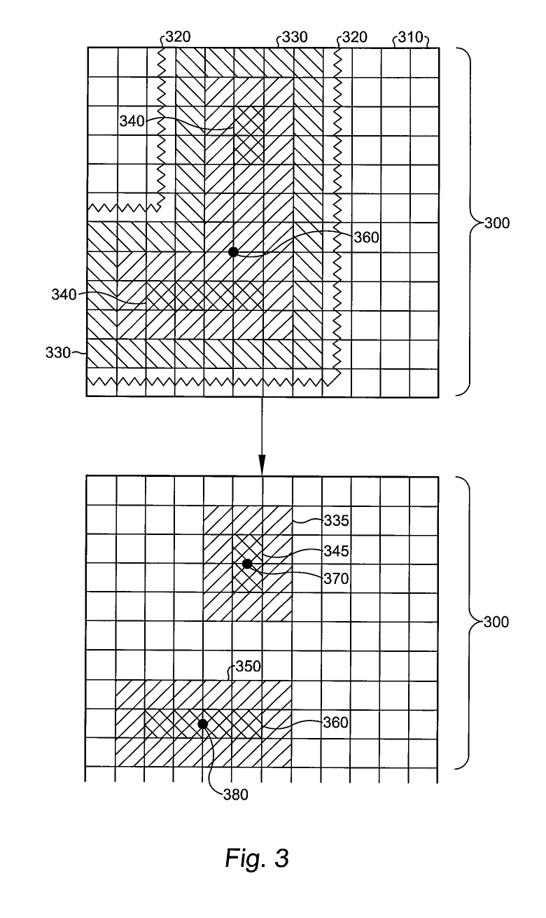

FIG. 3 shows a touch sensitive interface having overlapping regions of a two touch scenario that is resolved into two separate touch points according to one embodiment of the present invention. The touch sensitive interface 300 comprises a plurality of touch pads 310 which can sense an input based on an applied pressure. As is known to one skilled in the relevant art, the displacement or touch of a single touch pad can cause an impedance variation that can be measured and associated with a touch. The granularity of the touch sensitive interface 300 with respect to the number of touch pads 310 that are comprised within the interface 300 can vary; however, a touch generally results in a plurality of touch pads simultaneously registering an input. Thus an accurate determination of a touch coordinate from among the plurality of displaced touch pads 310 is needed.

FIG. 3 depicts two renditions of the same touch sensitive interface 300 experiencing the same touch. The upper portion of FIG. 3 illustrates the raw input of each touch pad 310 from within the touch sensitive interface 300 as registered upon the touch occurring. In its resting state prior to a touch, each touch pad 310 is associated with an established impedance measure which can be considered for discussion purposes as a base line. In FIG. 3 the blank touch pads 310 are representative of such a state. As shown the touch that is illustrated raises the impedance value of the touch pads 310 generally in the center of the touch sensitive interface 300 while the outlying pads remain unaffected.

The touch as shown in the upper portion of FIG. 3 is registered, in this example, as causing four distinct input levels in the affected touch pads 310. According to one embodiment of the present invention, input levels of each touch pad are incremental rather than contentious. Thus for illustrative purposes while an input may vary from 1 to 100, the values associated with each pad may be captured in increments of 10. Thus a pad having an input of 8 would be associated with a value of 10, a pad with an input of 12 would be associated with a value of 20 and so forth. In other embodiments continuous impedance values can be used.

Thus the illustrated touch in the upper portion of FIG. 3 possesses touch pads 320 associated with the periphery of the touch having a low input value yet one larger than the base line value. The touch area also possesses at least one peak region 340 in which input value is at a local maximum. FIG. 3 shows that the touch has two such peak regions 340. Interposed between the touch pads 310 on the periphery 320 and the peak regions 340 is a plurality of touch pads 330 having intermediate input values.

As previously discussed one method to determine a touch coordinate is to identify the boundary of the touch region and thereafter to identify the centroid of that identified region. Assuming all of the touch pads 320, 330, 340 highlighted in FIG. 3 are above a predetermined threshold, the centroid 360 of the touch region of the upper portion of FIG. 3, while formed using a weighted average of each touch pad's input, is displaced from either of the local maximum input values 340 yielding an inaccurate result. The existence of two local maximum areas 340 indicates that the touch shown in the upper portion of FIG. 3 comprises two touches that have occurred at substantially the same time.

According to one embodiment of the present invention, each local maximum 340 or seed point associated with a contact of an input sensitive interface 300 is identified, and thereafter a region surrounding each seed point is formed. From each region a centroid is located thus identifying an accurate portrayal of each touch coordinate. As shown in the lower portion of FIG. 3, the two local maximums 340 of the contact are isolated. A first local maximum 345 or seed point/value is identified from the upper region of the contact. The input value of each touch pad 335 surrounding the local maximum 345 is compared to the seed value. Once the seed point 345 is encased by input values less than that of the seed value, a region is identified. From that region a centroid 370 is determined.

In the same manner the local maximum 340 identified in the lower portion of the contact is identified as a second seed point 360. From that seed point 360 the input value of each surrounding touch pad 350 is examined and compared to the seed value to determine the extent of the region surrounding the seed point 360. Once the region is determined, a centroid 380 is calculated. In this manner the multiple touches of a touch sensitive interface 300 can be determined with minimal expenditure of resources.

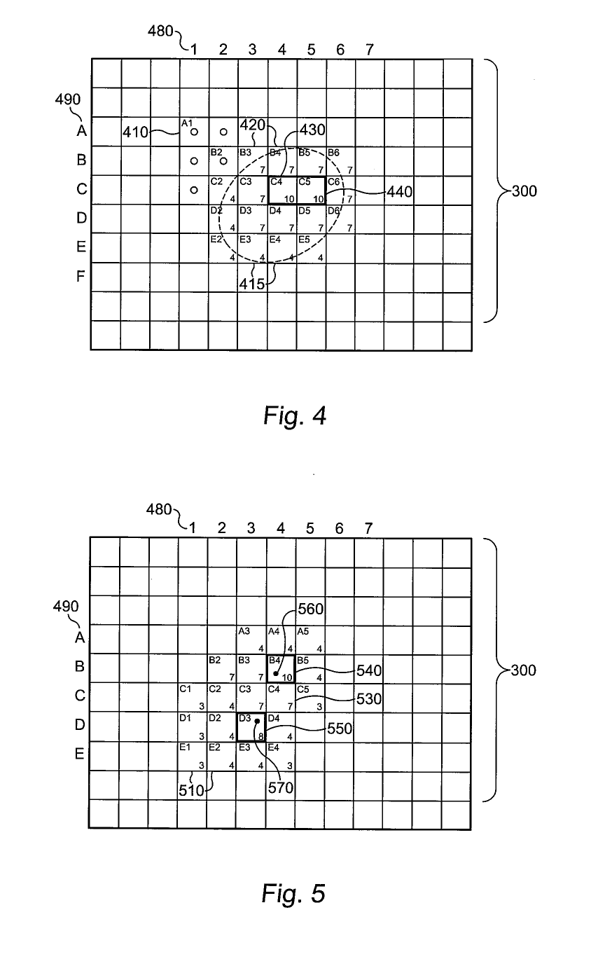

FIG. 4 shows a plurality of touch pad inputs on a touch sensitive interface 300 experiencing a single touch point according to one embodiment of the present invention. Included within the touch sensitive interface 300 is a plurality of touch pads. Each touch pad is individually identified, in this embodiment, by a coordinate. As shown each horizontal row of touch pads is associated with a letter 490 and each column of touch pads is associated with a numeral 480. Thus an individual touch pad can be identified by the combination of grid coordinates in the format (Letter, Numeral). In addition each touch pad is associated with an input value. At rest or when no contacts are present, the input value of each touch pad can be deemed below a predetermined noise level and considered to be zero. For illustrative purposes the touch pad at location A, 1 is shown to have an input value of zero. One skilled in the art will recognize that the actual input values for each touch pad will vary slightly even when no contact is present, however these values can be easily normalized and filtered by techniques known to one skilled in the relevant art.

Referring now to FIG. 4 and specifically to the contact area 415 found in the center of the touch sensitive interface 300, a plurality of touch pads have been identified as registering an input value. Each touch pad is shown with its discrete input value. For example the touch pads at locations B, 3 and B, 4 each have an input value of 7 while the input value of the touch pad at location C, 4 has an input value of 10.

According to one embodiment of the present invention, a screening filter is applied to all touch pad input values to determine when a contact has occurred. By using this predefined threshold, a contact registering even a small increase in input value can be identified. Thus in this example the filter would recognize that the input values of touch pads associated within the touch region 415 exceed the filter.

Pseudo code for such a filtering process can include:

```
INPUT: threshold
OUTPUT: Filtered data
For each P1 in SampleSpace2D
    If Imp [P1] < threshold then
        Imp [P1] = 0;
    End if
  End for
End for
```

All touch pads at which the input value exceeds the initial filter are examined to identify a maximum valued touch point. In this example, two touch points, C, 4 430 and C, 5 440 are identified as possessing an input value of 10. These points are designated as the seed point of the touch region. From each point the surrounding touch pad input values are compared to the seed point's input value to establish the boundary of the contact region.

Pseudo code for locating the peak and establishing the contact region can include for example:

```
INPUT: Impedance (P.Imp), THRES1, THRES2
OUTPUT: Island[ ]
//Pixel specification
    For Each P1 In SampleSpace2D
        For Each P1Neigh In P1.neighs
            If P1Neigh.Imp > P1.Imp + THRES1 then
              P1.Type = NORMAL;
              goto Exit_Loop;
            Elseif P1Neigh.Imp > P1.Imp − THRES2 then
              //P1 is a plateau
              P1.Type = PLATEAU;
              goto Exit_Loop;
            end
        end if
        //P1 is a peak
        P1.Type = PEAK;
    Exit_Loop:
    end for
INPUT: Impedance (P. Imp), THRES1, THRES2
OUTPUT: Island [ ]
//Pixel specification
For Each P1 In SampleSpace2D
  For Each P1Neigh In P1.neighs
    If P1Neigh.Imp > P1.Imp + THRES1 then
      P1.Type = NORMAL;
      goto Exit_Loop;
    Elseif P1Neigh.Imp > P1.Imp − THRES2 then
      //P1 is a plateau
      P1.Type = PLATEAU
      goto Exit_Loop;
      end
    end if
    //P1 is a peak
    P1.Type = PEAK;
Exit_Loop:
end for
For each P1 in SampleSpace2D
  If P1.type == PEAK then
    Island [id++].Add (P1);
    //Group all neigh as same group as peak
    For each P1Neigh in P1.neighborhood
      Island[id].Add(P1Neigh);
    End
  ElseIf P1.type == PLATEAU then
    SeedTable.Empty( ); //Initialize table
    SeedTable.Add(P1); //Add P1 as seed to grow
    Island[id].Add(P1); //Add P1 into island
    id++;
    For i = 0 to SeedTable.Len
      P1 = SeedTable.Entry(i);
      For each P1Neigh in P1.neighborhood
        //Add P1Neigh into island
        Island[ID].Add(P1Neigh);
        If P1Neigh.Type == PLATEAU then
          //Add P1Neigh as seed of next grow
          SeedTable.Add(P1Neigh);
          //Change P1Neigh type to avoid loop
          P1Neigh.Type = DE_PLATEAU
        End If
        End
      End for
    End if
  End for
```

For example, assume that after filtering a contact area has been identified as having a local maximum (peak) at touch pad C, 4 430. As shown the input value for C, 4 is 10. According to one embodiment of the present invention, the input value of each touch pad adjacent to touch pad C, 4 is compared to the input value of C, 4 (i.e. 10) to identify the boundary of the region. For example touch pad C, 3, having a value of 7, is identified as a boundary touch pad. Touch pad B, 3 also has a value of 7 and is also a boundary touch pad as are B, 4 and B, 5. However touch pad C, 5 possesses an identical input value of 10 and is thus not a boundary touch pad. The seed point is thus extended to encompass both touch pad C, 4 and C, 5. The investigation continues with respect to touch pads surrounding the seed point. As a result a region surrounding the seed point is associated with the contact and a centroid (touch coordinate), in this case located at the interface of touch pads C, 4 and C, 5, is determined.

Just as a single peak within a contact area can yield a region and a touch coordinate, so too can multiple peaks within a single contact area signify a multiple touch scenario yielding multiple touch coordinates. FIG. 5 shows a plurality of touch pad inputs on a touch sensitive interface 300 experiencing multiple touch points according to one embodiment of the present invention. As shown in FIG. 5 the contact area includes input values of 3, 4, 7, 8 and 10. A peak value of 10 is located at touch pad B, 4 540 but another local peak is found at touch pad D, 3 550. In both cases the input value associated with the touch pads that neighbor these two local peaks are less than local peak value. Thus according to one embodiment of the present invention, two distinct seed points 540, 550 are identified and two distinct regions are formed surrounding each point.

Once the region has been identified a centroid is determined to identify a touch point coordinate for each touch point within this single contact area. Note that the regions can, and in this case do, overlap. Touch pads C, 3 and C, 4 are associated with both the seed point at B, 4 and the seed point at D, 3. Furthermore, unlike the previous example in which each touch pad surrounding the seed point possessed an identical input value, the example illustrated in FIG. 5 shows that the touch pads surrounding each seed point possess varying input values. Accordingly the centroid of each region would apply a weighted application of the surrounding touch pads based on these input values. Thus the touch coordinate 560 for the first region may be located in the lower left portion of the touch pad B, 4, and the touch coordinate 570 for the second region may be located in the upper right portion of touch pad D, 3.

Pseudo code for such a weighted centroid determination can include:

INPUT: (none)
OUTPUT: (X_{centroid}, Y_{centroid})
Numerical = 0
Denominator = 0
For each sample in Island_X

| | |
|---|---|
| NumericalX | += Xₛₐₘₚₗₑ × Imp(sample) |
| DenominatorX | += Imp(sample) |
| NumericalY | += Yₛₐₘₚₗₑ × Imp(sample) |
| DenominatorY | += Imp(sample) |
| End for | |

Return ( (NumericalX/DenominatorX), (NumericalY/DenominatorY) )

While the example illustrated above shows a single contact having two adjacent and overlapping regions which form two distinct touch points, one skilled in the relevant art will recognize that the regions of a single contact could be distinct and non-overlapping. Furthermore two or more contact areas may occur within a touch sensitive interface wherein each contact area may comprise one or more touch points. These and other multiple touch point scenarios are contemplated and within the scope of the present invention.

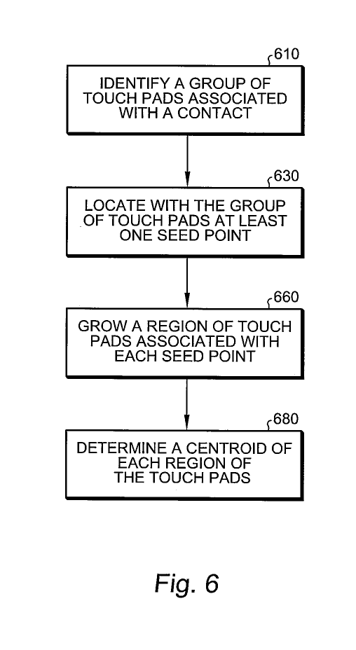

FIG. 6 is a flow chart illustrating methods of implementing an exemplary process for determining a touch coordinate associated with contact to a touch sensitive input device. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

One method embodiment for determining a touch coordinate for a touch sensitive interface according to the present invention is shown in FIG. 6. The process begins with identifying 610 a group of touch pads that is associated with a contact. This grouping of touch pads can be determined by applying a fixed threshold to eliminate samples (inputs) that are lower than the threshold and are likely associated with noise.

With one or more contact groups of touch pads established, one or more seed points within each contact group can be located 630 by identifying the touch pads with the largest relative input. From these seed points, a region can be grown 660 to surround each seed point based on the input value of each neighboring touch pad. Finally a weighted centroid of each region grown around the seed point can be determined 680 to identify a touch coordinate associated with that seed point.

In a preferred embodiment, the present invention can be implemented in firmware and/or software. Software programming code that embodies the present invention is typically accessed by a microprocessor from long-term, persistent storage media of some type, such as a flash drive or hard drive. The software programming code may be embodied on any of a variety of known media for use with a data processing system, such as a hard drive or CD-ROM. The code may be distributed on such media, or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory, on physical media, and/or distributing software code via networks are well known and will not be further discussed herein.

Generally, program modules include routines, programs, engines, objects, components, data structures and the like that perform particular tasks or implement particular abstract data types. Moreover, those skilled in the relevant art will appreciate that the invention can be practiced with other computer system configurations, including hand-held devices, multi-processor systems, microprocessor-based or programmable consumer electronics, network PCs, minicomputers, mainframe computers and the like or any system using a touch sensitive interface. The invention may also be practiced in distributed computing environments where tasks are performed by remote processing devices that are linked through a communications network. In a distributed computing environment, program modules may be located in both local and remote memory storage devices.

An exemplary system for implementing the invention includes a general purpose computing device in the form of a conventional personal computer, a personal communication device or the like. Such a system includes a processing unit, a system memory, and a system bus that couples various system components including the system memory to the processing unit. The system bus may be any of several types of bus structures including a memory bus or memory controller, a peripheral bus, and a local bus using any of a variety of bus architectures. The system memory generally includes read-only memory (ROM) and random access memory (RAM). A basic input/output system (BIOS), containing the basic routines that help to transfer information between elements within the personal computer, such as during start-up, is stored in ROM. The personal computer may further include a hard disk drive for reading from and writing to a hard disk and/or a magnetic disk drive for reading from or writing to a removable magnetic disk. The hard disk drive and magnetic disk drive are connected to the system bus by a hard disk drive interface and a magnetic disk drive interface respectively. The drives and their associated computer-readable media provide non-volatile storage of computer readable instructions, data structures, program modules and other data for the personal computer. Although the exemplary environment described herein employs a hard disk and a removable magnetic disk, it should be appreciated by those skilled in the art that other types of computer readable media which can store data that is accessible by a computer, such as flash memory cards, digital video disks, random access memories (RAMs), read-only memories (ROMs) and the like may also be used in the exemplary operating environment.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

While there have been described above the principles of the present invention in conjunction with determining touch coordinates associated with a touch sensitive interface, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

I claim:

1. A method for determining a touch coordinate associated with contact to a touch sensitive input device wherein the touch sensitive input device includes a plurality of touch pads, the method comprising:
identifying at least one plurality of touch pads associated with at least one contact;
locating at least one seed point within the at least one plurality of touch pads, the at least one seed point having an input greater than each neighboring touch pad's input value;
growing a region of touch pads associated with each seed point; and
determining a centroid of the region.

2. The method of claim 1 wherein the at least one plurality of touch pads is identified by filtering out inputs below a predetermined threshold.

3. The method of claim 1 wherein the at least one seed point includes two or more touch pads.

4. The method of claim 1 wherein each touch pad within the region is associated with a weighing factor.

5. The method of claim 4 wherein the centroid of the region is determined based on a weighted average of the weighing factor of each touch pad within the region.

6. The method of claim 1 wherein the at least one contact includes two or more distinct seed points indicating a multiple touch.

7. The method of claim 1 wherein the touch sensitive input device is a touch sensitive screen.

8. The method of claim 1 wherein the touch sensitive input device measures impedance values of each touch pad.

9. The method of claim 1 wherein the region includes the at least one seed point and at least one set of touch pads having an input level less than that of the at least one seed point.

10. The method of claim 1 wherein locating includes distinguishing between two or more seed points within the associated at least one plurality of touch pads associated with the contact.

11. A computer system for determining at least one touch coordinate on a touch sensitive input device, the computer system comprising:
a machine capable of executing instructions embodied as software; and
a plurality of software portions, wherein:
one of said software portions is operable to receive contact information from the touch sensitive input device;
one of said software portions is operable to identify at least one plurality of touch pads associated with at least one contact;
one of said software portions is operable to locate at least one seed point within the at least one plurality of touch pads, the at least one seed point having an input value greater than each neighboring touch pad's input value;
one of said software portions is operable to grow a region of touch pads associated with each seed point; and
one of said software portions is operable to determine a centroid of the region as the at least one touch coordinate.

12. The computer system of claim 11 wherein the at least one plurality of touch pads is identified by filtering out inputs below a predetermined threshold.

13. The computer system of claim 11 wherein each touch pad within the region is associated with a weighing factor.

14. The computer system of claim 13 wherein the centroid of the region is determined based on a weighted average of the weighing factor of each touch pad within the region.

15. The computer system of claim 12 wherein the at least one contact includes two or more distinct seed points indicating a multiple touch.

16. The computer system of claim 12 wherein the region includes the at least one seed point and at least one set of touch pads having an input level less than that of the at least one seed point.

17. A computer-readable storage medium tangibly embodying a program of instructions executable by a machine wherein said program of instructions comprises a plurality of program codes for determining a touch coordinate on a touch sensitive input device, said program of instructions comprising:
program code for identifying at least one plurality of touch pads associated with at least one contact of the touch sensitive input device wherein each touch pad associated with the at least one contact has an input value;
program code for locating at least one seed point within the at least one plurality of touch pads, the input value of the at least one seed point being greater than the input value of each neighboring touch pad;
program code for growing a region of touch pads associated with each seed point; and
program code for determining a centroid of the region.

18. The computer-readable storage medium embodying the program of instructions of claim 17, said program of instructions further comprising program code for associating each touch pad within the region with a weighing factor.

19. The computer-readable storage medium embodying the program of instructions of claim 18, wherein said program code for determining the centroid of the region is based on a weighted average of the weighing factor of each touch pad within the region.

20. The computer-readable storage medium embodying the program of instructions of claim 18, wherein the at least one contact of the touch sensitive input device includes two or more distinct seed points indicating a multiple touch.
